(19) United States
(12) Patent Application Publication
(10) Pub. No.: US 2004/0202935 A1
(43) Pub. Date: Oct. 14, 2004

(54) Cathode active material with increased alkali/metal content and method of making same

(76) Inventors: Jeremy Barker, Oxfordshire (GB); M. Yazid Saidi, Henderson, NV (US); Jeffrey Swoyer, Henderson, NV (US)

Correspondence Address: VALENCE TECHNOLOGY, INC., 301 CONESTOGA WAY, HENDERSON, NV, 89015, US

(21) Appl. No.: 10/409,847

(22) Filed: Apr. 8, 2003

(51) Int. Cl. H01M 4/58

(52) U.S. Cl. 429/231.9; 429/231.95; 429/231.5; 429/224; 429/223; 429/220; 429/225; 423/306

(57) ABSTRACT

The invention provides an electrochemical cell which includes a first electrode and a second electrode which is a counter electrode to said first electrode, and an electrolyte material interposed there between. The first electrode includes an active material having a high proportion of alkali metal per formula unit of material.

### FIELD OF THE INVENTION

This invention relates to improved electrode active materials having a high proportion of alkali metal per formula unit of material, methods for making such improved materials, and electrochemical cells employing such improved materials.

### BACKGROUND OF THE INVENTION

A battery consists of one or more electrochemical cells, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

The positive electrode of such batteries generally includes an electrochemically active material that has a crystal lattice structure or framework from which ions can be extracted, and subsequently reinserted. In general, positive electrode materials should exhibit a high free energy of reaction with the cation (e.g. Li⁺, Na⁺, and the like), be able to release and insert a large quantity of cations, maintain its lattice structure upon insertion and extraction of cations, allow rapid diffusion of cations, afford good electrical conductivity, be not significantly soluble in the electrolyte system of the battery, and be readily and economically produced One class of known electrode materials has a NASICON framework. “NASICON” electrode materials are generally represented by the general formula A₃M₂(PO₄)₃, wherein A is an alkali metal, and M is at least one transition metal. Compounds having the rhombohedral NASICON structure form a framework of MO₆ octahedra sharing all of their corners with the PO₄ (or its equivalent moiety) tetrahedra. Pairs of MO₆ octahedra have faces bridged by three PO₄ tetrahedra to form “lantern” units aligned parallel to the hexagonal c-axis (the rhomobhedral [111] direction), and each of these PO₄ tetrahedra (or its equivalent moiety) bridge to two different “lantern” units. The alkali metal ions occupy the interstitial space within the NASICON framework structure.

Unfortunately, many existing NASICON-based electrode materials are not economical to produce, afford insufficient voltage, have insufficient charge capacity, or lose their ability to be recharged over multiple cycles. Therefore, there is a current need for a NASICON-based electrode material that exhibits greater charge capacity, is economical to produce, affords sufficient voltage, and retains capacity over multiple cycles.

### SUMMARY OF THE INVENTION

The present invention provides novel alkali metal-containing materials having a high proportion of alkali metal per formula unit of material. Upon electrochemical interaction, such materials allow extraction of alkali metal cations, and are capable of reversibly cycling alkali metal cations. The alkali metal-containing materials of the present invention are represented by the general nominal formula (I):

AₐM₂₋ₘ^{I}Mₘ^{II}(XY₄)₃, (I)

wherein:

(i) A is at least one alkali metal, wherein a=3+m and 3≦a≦5;

(ii) M^{I} is selected from the group consisting of a redox active element with a 2+ oxidation state, a redox active element with a 3+ oxidation state, and mixtures thereof;

(iii) M^{II} is selected from the group consisting of a redox active element with a 2+ oxidation state, a redox active element with a 3+ oxidation state, a non-redox active element with a 2+ oxidation state, a non-redox active element with a 3+ oxidation state, and mixtures thereof, wherein 0≦m≦2; and

(iv) XY₄ is selected from the group consisting of X′[O₄₋ₓ,Y′ₓ], X′[O_{4-y},Y′_{2y}], X″S₄, [X_{z}′″,X′_{1-z}]O₄, and mixtures thereof, wherein:

(a) X′ and X′″ are each independently selected from the group consisting of P, As, Sb, Si, Ge, V, S, and mixtures thereof;

(b) X″ is selected from the group consisting of P, As, Sb, Si, Ge, V, and mixtures thereof;

(c) Y′ is selected from the group consisting of a halogen, S, N, and mixtures thereof; and

(d) 0≦x≦3,and 0≦y≦2;

wherein at least one of M^{I} and M^{II} is redox active as defined herein below, and wherein A, M^{I}, M^{II}, X, Y, a, m, x, y and z are selected so as to maintain electroneutrality of the material.

This invention also provides electrodes which utilize the electrode active material of this invention. Also provided are batteries that include a first electrode having the electrode active material of this invention; a second counter electrode having a compatible active material; and an electrolyte. In a preferred embodiment, the novel electrode active material of this invention is used as a positive electrode (cathode) active material, reversibly cycling alkali metal cations with a compatible negative electrode (anode).

### BRIEF DESCRIPTION OF THE DRAWINGS

FIG. 1 is a plot of the cathode specific capacity as a function of voltage for n electrochemical cell constructed from Li₄NiV(PO₄)₃ active material.

FIG. 2 is a plot of the cathode specific capacity as a function of voltage for an electrochemical cell constructed from Li₄CoV(PO₄)₃ active material

FIG. 3 is a plot of the cathode specific capacity as a function of voltage for an electrochemical cell constructed from Li₄MnV(PO₄)₃ active material.

FIG. 4 is a plot of the cathode specific capacity as a function of voltage for an electrochemical cell constructed from Li₄VFe(PO₄)₃ active material.

FIG. 5 is a plot of the cathode specific capacity as a function of voltage for an electrochemical cell constructed from Li₄SnV(PO₄)₃ active material

FIG. 6 is a plot of the cathode specific capacity as a function of voltage for an electrochemical cell constructed from Li₅V₂(PO₄)₃ active material.

### DETAILED DESCRIPTION OF THE PREFERRED EMBODIMENTS

It has been found that the novel electrode materials, electrodes, and batteries of this invention afford benefits over such materials and devices among those known in the art. Such benefits include one or more of increased capacity, enhanced ionic and electrical conductivity, enhanced cycling capability, enhanced reversibility, and reduced costs. Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

The present invention provides electrode active materials for use in an electricity-producing electrochemical cell. Each electrochemical cell includes a positive electrode, a negative electrode, and an electrolyte in ion-transfer communication with both the positive and the negative electrode for transferring ionic charge carriers there between. A “battery” refers to a device having one or more electricity-producing electrochemical cells. Two or more electrochemical cells may be combined, or “stacked,” so as to create a multi-cell battery.

The electrode active materials of this invention may be used in the negative electrode, the positive electrode, or both. Preferably, the active materials of this invention are used in the positive electrode. As used herein, the terms “negative electrode” and “positive electrode” refer to the electrodes at which oxidation and reduction occur, respectively, during battery discharge; during charging of the battery, the sites of oxidation and reduction are reversed.

Electrode Active Materials:

The present invention is directed to novel alkali metal-containing electrode active materials having a high proportion of alkali metal per formula unit of material. Such electrode active materials have a NASI CON structure, and are represented by the general nominal formula (I):

AₐM₂₋ₘ^{I}Mₘ^{II}(XY₄)₃. (I)

The term “nominal formula” refers to the fact that the relative proportion of atomic species may vary slightly on the order of 2 percent to 5 percent, or more typically, 1 percent to 3 percent.

A of general formula (I) is an alkali metal or a mixture of alkali metals. In one embodiment, A is selected from the group consisting of Li (Lithium), Na (Sodium), K (Potassium), and mixtures thereof. A may be a mixture of Li with Na, a mixture of Li with K, or a mixture of Li, Na and K. In another embodiment, A is Na, or a mixture of Na with K. In one preferred embodiment, A is Li.

As used herein, the recitation of a genus of elements, materials or other components, from which an individual component or mixture of components can be selected, is intended to include all possible sub-generic combinations of the listed components, and mixtures thereof. In addition, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

A sufficient quantity of alkali metal (A) should be present so as to allow all of the “redox active” elements of M^{I} and/or M^{II} (as defined herein below) to undergo oxidation/reduction. In one embodiment, 3≦a≦5. In another embodiment, 3≦a≦5, a=3+m, and 0≦m≦2. In yet another embodiment, 3≦a≦5. In another embodiment, 3≦a≦5, a=3+m, and 0≦m≦2. Unless otherwise specified, a variable described herein algebraically as equal to (“=”), less than or equal to (“≦”), or greater than or equal to (“>”) a number is intended to subsume values or ranges of values about equal or functionally equivalent to said number.

Removal of alkali metal from the electrode active material is accompanied by a change in oxidation state of the redox active elements of M^{I} and/or M^{II} (or where M^{I} and/or M^{II} consist of more than one element, by a change in oxidation state of at least one of those elements). The amount of M^{I} and/or M^{II} that is available for oxidation in the electrode active material determines the amount of alkali metal that may be removed. Such concepts are, in general, well known in the art, e.g., as disclosed in U.S. Pat. No. 4,477,541, Fraioli, issued Oct. 16, 1984; and U.S. Pat. No. 6,136,472, Barker, et al., issued Oct. 24, 2000, both of which are incorporated by reference herein.

M^{I} of general formula (I) is selected from the group consisting of a redox active element with a 2+ oxidation state, a redox active element with a 3+ oxidation state, and mixtures thereof. As used herein, the term “redox active element” includes those elements characterized as being capable of undergoing oxidation/reduction to another oxidation state when the electrochemical cell is operating under normal operating conditions. As used herein, the term “normal operating conditions” refers to the intended voltage at which the cell is charged, which, in turn, depends on the materials used to construct the cell.

Redox active elements useful herein with respect to both M^{I} and M^{II} include, without limitation, elements from Groups 4 through 11 of the Periodic Table, as well as select non-transition metals, including, without limitation, Ti (Titanium), V (Vanadium), Cr (Chromium), Mn (Manganese), Fe (Iron), Co (Cobalt), Ni (Nickel), Cu (Copper), Nb (Niobium), Mo (Molybdenum), Ru (Ruthenium), Rh (Rhodium), Pd (Palladium), Os (Osmium), Ir (Iridium), Pt (Platinum), Au (Gold), Si (Silicon), Sn (Tin), Pb (Lead), and mixtures thereof. As referred to herein, “Group” refers to the Group numbers (i.e., columns) of the Periodic Table as defined in the current IUPAC Periodic Table. See, e.g., U.S. Pat. No. 6,136,472, Barker et al., issued Oct. 24, 2000, incorporated by reference herein. Also, as used herein, the word “include,” and its variants, is intended to be non-limiting, such that recitation of items in a list is not to the exclusion of other like items that may also be useful in the materials, compositions, devices, and methods of this invention.

In one embodiment, M^{I} is at least one redox active first row transition metal with a 2+ and/or a 3+ oxidation state, and is selected from the group consisting of Ti, V, Cr, Mn, Fe, Co, Ni, Cu, and mixtures thereof. In another embodiment, M^{I} is at least one redox active element metal with a 2+ oxidation state, and is selected from the group consisting of Ti, V, Cr, Mn, Fe, Co, Ni, Cu, Mo, Si, Sn, Pb, and mixtures thereof. In another embodiment, M^{I} is at least one redox active transition metal with a 3+ oxidation state, and is selected from the group consisting of Ti, V, Cr, Mn, Fe, Co, Ni, Mo, Nb, and mixtures thereof.

Referring again to general formula (I), M^{II} is selected from the group consisting of a redox active element with a 2+ oxidation state, a redox active element with a 3+ oxidation state, a non-redox active element with a 2+ oxidation state, a non-redox active element with a 3+ oxidation state, and mixtures thereof. As referred to herein, “non-redox active elements” include elements that are capable of forming stable active materials, and do not undergoing oxidation/reduction when the electrode active material is operating under normal operating conditions.

Among the non-redox active elements useful herein include, without limitation, those selected from the group consisting of Group 2 elements, particularly Be (Beryllium), Mg (Magnesium), Ca (Calcium), Sr (Strontium), Ba (Barium); Group 3 elements, particularly Sc (Scandium), Y (Yttrium), and the lanthanides, particularly La (Lanthanum), Ce (Cerium), Pr (Praseodymium), Nd (Neodymium), Sm (Samarium); Group 12 elements, particularly Zn (Zinc) and Cd (Cadmium); Group 13 elements, particularly B (Boron), Al (Aluminum), Ga (Gallium), In (Indium), Tl (Thallium); Group 14 elements, particularly C (Carbon) and Ge (Germanium), Group 15 elements, particularly As (Arsenic), Sb (Antimony), and Bi (Bismuth); Group 16 elements, particularly Te (Tellurium); and mixtures thereof.

In one embodiment, M^{II} is at least one non-redox active element metal with a 2+ oxidation state, and is selected from the group consisting of Be, Mg, Ca, Sr, Ba, Zn, Cd, C, Ge and mixtures thereof. In another embodiment, M^{II} is at least one non-redox active transition metal with a 3+ oxidation state, and is selected from the group consisting of Sc, Y, B, and mixtures thereof.

In those embodiments where M^{II} is a non-redox active element or a mixture of non-redox active elements, 0<m<2. However, in those embodiments where M^{II} includes at least one redox active element, 0≦m≦2.

Referring again to general formula (I), XY₄ is an anion selected from the group consisting of X′[O₄₋ₓ,Y′ₓ], X′[O_{4-y},Y′_{2y}], X″S₄, [X_{z}′″,X′_{1-z}]O₄, and mixtures thereof,

wherein:

(a) X′ and X′″ are each independently selected from the group consisting of P, As, Sb, Si, Ge, V, S, and mixtures thereof;

(b) X″ is selected from the group consisting of P, As, Sb, Si, Ge, V, and mixtures thereof;

(c) Y′ is selected from the group consisting of a halogen, S, N, and mixtures thereof; and

(d) 0≦x≦3, 0≦y≦2, and 0≦z≦1

In one embodiment, XY₄ is selected from the group consisting of X′[O₄₋ₓ,Y′ₓ], X′[O_{4-y},Y′_{2y}], and mixtures thereof, and x and y are both 0. Stated differently, XY₄ is an anion selected from the group consisting of PO₄, SiO₄, GeO₄, VO₄, AsO₄, SbO₄, SO₄, and mixtures thereof. Preferably, XY₄ is PO₄ or a mixture of PO₄ with another anion of the above-noted group (i.e., where X′ is not P, Y′ is not O, or both, as defined above). In one embodiment, XY₄ includes about 80% or more phosphate and up to about 20% of one or more of the above-noted anions.

In another embodiment, XY₄ is selected from the group consisting of X′[O₄₋ₓ,Y′ₓ], X′[O_{4-y},Y′_{2y}], and mixtures thereof, wherein 0≦x ≦3 and 0≦y≦2, and wherein a portion of the oxygen (O) in the XY₄ moiety is substituted with a halogen, S, N, or a mixture thereof.

Methods of Manufacture:

The particular starting materials employed will depend on the particular active material to be synthesized, reaction method employed, and desired by-products. The active materials of the present invention are synthesized by reacting at least one alkali metal-containing compound, at least one M^{I} and/or M^{II}-containing compound, at least one XY₄-containing compound, at a temperature and for a time sufficient to form the desired reaction product. As used herein, the term “containing” includes compounds which contain the particular component, or react to form the particular component so specified.

Sources of alkali metal include any of a number of alkali metal-containing salts or ionic compounds. Lithium, sodium, and potassium compounds are preferred, with lithium being particularly preferred. A wide range of such materials is well known in the field of inorganic chemistry. Examples include the alkali metal-containing fluorides, chlorides, bromides, iodides, nitrates, nitrites, sulfates, hydrogen sulfates, sulfites, bisulfites, carbonates, bicarbonates, borates, phosphates, silicates, antimonates, arsenates, germanates, oxides, acetates, oxalates, and the like. Hydrates of the above compounds may also be used, as well as mixtures thereof. The mixtures may contain more than one alkali metal so that a mixed alkali metal active material will be produced in the reaction.

Sources of M^{I} and M^{II} include fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germanates, oxides, hydroxides, acetates, and oxalates of the same. Hydrates may also be used. The element(s) M^{I} and M^{II} in the starting material may have any oxidation state, depending on the oxidation state required in the desired product and the oxidizing or reducing conditions contemplated. It should be noted that many of the above-noted compounds may also function as a source of the XY₄ moiety.

As noted above, the active materials of general formula (I) can contain one or more XY₄ groups, or can contain a phosphate group that is completely or partially substituted by one or more other XY₄ moieties, which will also be referred to as “phosphate replacements” or “modified phosphates.” Thus, active materials are provided according to the invention wherein the XY₄ moiety is a phosphate group that is completely or partially replaced by such moieties as SiO₄, GeO₄, VO₄, AsO₄, SbO₄, SO₄, and mixtures thereof. Analogues of the above oxygenate anions where some or all of the oxygen is replaced by sulfur are also useful in the active materials of the invention, with the exception that the sulfate group may not be completely substituted with sulfur. For example, thiomonophosphates may also be used as a complete or partial replacement for phosphate in the active materials of the invention. Such thiomonophosphates include the anions (PO₃S)³⁻, (PO₂S₂)³⁻, (POS₃)₃₋, and (PS₄)³⁻, and are most conveniently available as the sodium, lithium, or potassium derivative. Non-limiting examples of sources of monofluoromonophosphates include, without limitation, Na₂PO₃F, K₂PO₃F, (NH₄)₂PO₃F.H₂O, LiNaPO₃F.H₂O, LiKPO₃F, LiNH₄PO₃F, NaNH₄PO₃F, NaK₃(PO₃F)₂ and CaPO₃F.2H₂O. Representative examples of sources of difluoromonophosphate compounds include, without limitation, NH₄PO₂F₂, NaPO₂F₂, KPO₂F₂, Al(PO₂F₂)₃, and Fe(PO₂F₂)₃.

Sources for the XY₄ moiety are common and readily available. For example, where X is Si, useful sources of silicon include orthosilicates, pyrosilicates, cyclic silicate anions such as (Si₃O₉)⁶⁻, (Si₆O₁₈)¹²⁻ and the like, and pyrocenes represented by the formula [(SiO₃)²⁻]ₙ, for example LiAl(SiO₃)₂. Silica or SiO₂ may also be used. Representative arsenate compounds that may be used to prepare the active materials of the invention wherein X is As include H₃AsO₄ and salts of the anions [H₂AsO₄]⁻ and [HAsO₄]²⁻. Where X is Sb, antimonate can be provided by antimony-containing materials such as Sb₂O₅, M^{I}SbO₃ where M^{I} is a metal having oxidation state 1+, M^{III}SbO₄ where M^{III} is a metal having an oxidation state of 3+, and M^{II}Sb₂O₇ where M^{II} is a metal having an oxidation state of 2+. Additional sources of antimonate include compounds such as Li₃SbO₄, NH₄H₂SbO₄, and other alkali metal and/or ammonium mixed salts of the [SbO₄]³⁻ anion. Where X is S, sulfate compounds that can be used include alkali metal and transition metal sulfates and bisulfates as well as mixed metal sulfates such as (NH₄)₂Fe(SO₄)₂, NH₄Fe(SO₄)₂ and the like. Finally, where X is Ge, a germanium containing compound such as GeO₂ may be used to synthesize the active material.

Where Y′ of the X′O₄₋ₓY′ₓ and X′O₄₋Y′_{2y} moieties is F, sources of F include ionic compounds containing a fluoride ion (F⁻) or hydrogen difluoride ion (HF₂⁻). The cation may be any cation that forms a stable compound with the fluoride or hydrogen difluoride anion. Examples include 1+, 2+ and 3+ metal cations, as well as ammonium and other nitrogen-containing cations. Ammonium is a preferred cation because it tends to form volatile by-products that are readily removed from the reaction mixture. Similarly, to make X′O₄₋ₓNₓ, starting materials are provided that contain “x” moles of a source of nitride ion. Sources of nitride are among those known in the art including nitride salts such as Li₃N and (NH₄)₃N.

As noted above, the active materials of general formula (I) contain a mixture of A, M^{I}, M^{II}, and XY₄. A starting material may provide more than one of these components, as is evident from the list above. In various embodiments of the invention, starting materials are provided that combine, for example, M^{I} and/or M^{II} and PO₄, thus requiring only the alkali metal to be added. In one embodiment, a starting material is provided that contains A, M^{I} or M^{II} and PO₄. As a general rule, there is sufficient flexibility to allow selection of starting materials containing any of the components of A, M^{I}, M^{II}, and XY₄, depending on availability. Combinations of starting materials providing each of the components may also be used.

In general, any counterion may be combined with A, M^{I}, M^{II}, and XY₄. It is preferred, however, to select starting materials with counterions that give rise to the formation of volatile by-products during the reaction. Thus, it is desirable to choose ammonium salts, carbonates, bicarbonates, oxides, hydroxides, and the like, where possible. Starting materials with these counterions tend to form volatile by-products such as water, ammonia, and carbon dioxide, which can be readily removed from the reaction mixture. Similarly, sulfur-containing anions such as sulfate, bisulfate, sulfite, bisulfite and the like tend to result in volatile sulfur oxide by-products. Nitrogen-containing anions such as nitrate and nitrite also tend to give volatile NOₓ by-products.

One method for preparing the active materials of the present invention is via the hydrothermal treatment of the requisite starting materials, namely: at least one alkali metal-containing compound, at least one M^{I} and/or M^{II}-containing compound, at least one XY₄-containing compound, and (optionally) one or more reducants or reducing agents. In a hydrothermal reaction, the starting materials are mixed with a small amount of a liquid (e.g. water), and heated in a pressurized vessel or bomb at a temperature that is relatively lower as compared to the temperature necessary to produce the active material in an oven at ambient pressure. Preferably, the reaction is carried out at a temperature of about 150° C. to about 450° C., under pressure, for a period of about 4 to about 48 hours, or until a reaction product forms.

Another method for synthesizing the active materials of the present invention is via a thermite reaction, wherein M^{I} and/or M^{II} is reduced by a granular or powdered metal present in the reaction mixture.

The active materials of the present invention can also be synthesized via a solid state reaction, with or without simultaneous oxidation or reduction of M^{I} and/or M^{II}, by heating the requisite starting materials at an elevated temperature for a given period of time, until the desired reaction product forms. In a solid-state reaction, the starting materials are provided in powder or particulate form, and are mixed together by any of a variety of procedures, such as by ball milling, blending using a mortar and pestle, and the like. Typically, the starting materials are ball milled for 12-18 hours, rolling at a rate of 20 rpm.

Thereafter the mixture of powdered starting materials may be compressed into a pellet and/or held together with a binder material (which may also serve as a source of the reducing agent) to form a closely cohering reaction mixture. The reaction mixture is heated in an oven, generally at a temperature of about 400° C. or greater, until a reaction product forms.

The reaction may be carried out under reducing or oxidizing conditions. Reducing conditions may be provided by performing the reaction in a “reducing atmosphere” such as hydrogen, ammonia, carbon monoxide, methane, or mixtures thereof, or other suitable reducing gas. Alternatively or in addition thereto, the reduction may be carried out in situ by including in the reaction mixture a reducant that will participate in the reaction to reduce M^{I} and/or M^{II}, and produce by-products that will not interfere with the active material when used later in an electrode or an electrochemical cell.

In one embodiment, the reducant is elemental carbon, wherein the reducing power is provided by simultaneous oxidation of carbon to carbon monoxide and/or carbon dioxide. An excess of carbon, remaining after the reaction, is intimately mixed with the product active material and functions as a conductive constituent in the ultimate electrode formulation. Accordingly, excess carbon, on the order of 100% or greater, may be used. The presence of carbon particles in the starting materials also provides nucleation sites for the production of the product crystals.

The source of reducing carbon may also be provided by an organic material that forms a carbon-rich decomposition product, referred to herein as a “carbonaceous material,” and other by-products upon heating under the conditions of the reaction. At least a portion of the organic precursor, carbonaceous material and/or by-products formed by decomposition functions as a reducant during the synthesis reaction for the active material, before, during and/or after the organic precursor undergoes thermal decomposition. Such precursors include any liquid or solid organic material (e.g. sugars and other carbohydrates, including derivatives and polymers thereof).

Although the reaction may be carried out in the presence of oxygen, the reaction is preferably conducted under an essentially non-oxidizing atmosphere so as not to interfere with the reduction reactions taking place. An essentially non-oxidizing atmosphere can be achieved through the use of a vacuum, or through the use of inert gases such as argon, nitrogen, and the like.

Preferably, the particulate starting materials are heated to a temperature below the melting point of the starting materials. The temperature should be about 400° C. or greater, and desirably about 450° C. or greater. CO and/or CO₂ evolve during the reaction. Higher temperatures favor CO formation. Some of the reactions are more desirably conducted at temperatures greater than about 600° C.; most desirably greater than about 650° C. Suitable ranges for many reactions are from about 500 to about 1200° C.

At about 700° C. both the C [symbol] CO and the C [symbol] CO₂ reactions are occurring. At closer to about 600° C. the C [symbol] CO₂ reaction is the dominant reaction. At closer to about 800° C. the C [symbol] CO reaction is dominant. Since the reducing effect of the C [symbol] CO₂ reaction is greater, the result is that less carbon is needed per atomic unit of M^{I} and/or M^{II} to be reduced.

The starting materials may be heated at ramp rates from a fraction of a degree up to about 10° C. per minute. In some cases, for example where continuously heated rotary furnaces are employed, the ramp rate may be significantly higher. Once the desired reaction temperature is attained, the reactants (starting materials) are held at the reaction temperature for a time sufficient for the reaction to occur. Typically, the reaction is carried out for several hours at the final reaction temperature.

After the reaction is complete, the products are preferably cooled from the elevated temperature to ambient (room) temperature (i.e., about 10° C. to about 40° C.). It is also possible to quench the products to achieve a higher cooling rate, for example on the order of about 100° C./minute. The thermodynamic considerations such as ease of reduction of the selected starting materials, the reaction kinetics, and the melting point of the salts will cause adjustment in the general procedure, such as the amount of reducing agent, the temperature of the reaction, and the dwell time.

Electrochemical Cells:

To form an electrode of an electrochemical cell, active material of the present invention is combined with other suitable materials (e.g. a polymeric binder, current collector, an electrically conductive agent such as carbon, and the like). To form an electrochemical cell, a liquid or solid electrolyte is placed in ion-transfer relationship with the above-mentioned electrode and a counter electrode. Where required, a separator element may be positioned between the electrodes. Counter electrodes, electrolyte compositions, and methods for making the same, among those useful herein, are described in U.S. Pat. No. 5,700,298, Shi et al., issued Dec. 23, 1997; U.S. Pat. No. 5,830,602, Barker et al., issued Nov. 3, 1998; U.S. Pat. No. 5,418,091, Gozdz et al., issued May 23, 1995; U.S. Pat. No. 5,508,130, Golovin, issued Apr. 16, 1996; U.S. Pat. No. 5,541,020, Golovin et al., issued Jul. 30, 1996; U.S. Pat. No. 5,620,810, Golovin et al., issued Apr. 15, 1997; U.S. Pat. No. 5,643,695, Barker et al., issued Jul. 1, 1997; U.S. Pat. No. 5,712,059, Barker et al., issued Jan. 27, 1997; U.S. Pat. No. 5,851,504, Barker et al., issued Dec. 22, 1998; U.S. Pat. No. 6,020,087, Gao, issued Feb. 1, 2001; and U.S. Pat. No. 6,103,419, Saidi et al., issued Aug. 15, 2000; all of which are incorporated by reference herein.

Electrochemical cells composed of electrodes, electrolytes and other materials, among those useful herein, are described in the following documents, all of which are incorporated by reference herein: U.S. Pat. No. 4,668,595, Yoshino et al., issued May 26, 1987; U.S. Pat. No. 4,792,504, Schwab et al., issued Dec. 20, 1988; U.S. Pat. No. 4,830,939, Lee et al., issued May 16, 1989; U.S. Pat. No. 4,935,317, Fauteaux et al., issued Jun. 19, 1980; U.S. Pat. No. 4,990,413, Lee et al., issued Feb. 5, 1991; U.S. Pat. No. 5,037,712, Shackle et al., issued Aug. 6, 1991; U.S. Pat. No. 5,262,253, Golovin, issued Nov. No. 16, 1993; U.S. Pat. No. 5,300,373, Shackle, issued Apr. 5, 1994; U.S. Pat. No. 5,399,447, Chaloner-Gill, et al., issued Mar. 21, 1995; U.S. Pat. No. 5,411,820, Chaloner-Gill, issued May 2, 1995; U.S. Pat. No. 5,435,054, Tonder et al., issued Jul. 25, 1995; U.S. Pat. No. 5,463,179, Chaloner-Gill et al., issued Oct. 31, 1995; U.S. Pat. No. 5,482,795, Chaloner-Gill., issued Jan. 9, 1996; U.S. Pat. No. 5,660,948, Barker, issued Sep. 16, 1995; and U.S. Pat. No. 6,306,215, Larkin, issued Oct. 23, 2001.

The following non-limiting examples illustrate the compositions and methods of the present invention.

### EXAMPLE 1

An electrode active material having the formula Li₄NiV(PO₄)₃ is made as follows. The following starting materials are provided, and the reaction proceeds as follows.

3 (NH₄)₂HPO₄ + 2 Li₂CO₃ + NiO + 0.5 V₂O₅ + C →
Li₄NiV(PO₄)₃ + CO + 2 CO₂ + 4.5 H₂O + 6 NH₃

| | |
|---|---|
| 0.04 moles Li₂CO₃ (mol. wt. = 73.88 g/mol) | 2.96 g |
| 0.01 mole V₂O₅ (181.9 g/mol) | 1.82 g |
| 0.02 mole NiO (74.69 g/mol) | 1.49 g |
| 0.06 moles (NH₄)₂HPO₄ (132.06 g/mol) | 7.92 g |
| 0.02 moles elemental carbon (12 g/mol) | 0.24 g |

The above starting materials are combined and ball milled to mix the particles. Thereafter, the particle mixture is pelletized. The pelletized mixture is heated for 8 hours at about 600° C. in an oven in a hydrogen atmosphere. Thereafter, the sample is removed from the oven and cooled. Electrode active material synthesized by this method was hard and exhibited a grey color. The procedure was then repeated, except that the pelletized mixture was heated for 8 hours at 850° C. The reaction product was hard and blue/green in color.

### EXAMPLE 2

An electrode active material having the formula Li₄CoV(PO₄)₃ is made as follows, using the reaction conditions of Example 1. The following starting materials are provided, and the reaction proceeds as follows.

3 (NH₄)₂HPO₄ + 2 Li₂CO₃ + CoO + 0.5 V₂O₅ + C →
Li₄CoV(PO₄)₃ + CO + 2 CO₂ + 4.5 H₂O + 6 NH₃

| | |
|---|---|
| 0.04 moles Li₂CO₃ (mol. wt. = 73.88 g/mol) | 2.96 g |
| 0.01 moles V₂O₅ (181.9 g/mol) | 1.82 g |
| 0.02 moles CoO (74.93 g/mol) | 1.50 g |
| 0.06 moles (NH₄)₂HPO₄ (132.06 g/mol) | 7.92 g |
| 0.02 moles elemental carbon (12 g/mol) | 0.24 g |

The above-noted mixture is then subjected to the reaction conditions specified in Example 1 to form the Li₄CoV(PO₄)₃ active material. When the above-noted reactants were heated for 8 hours at 600° C., a soft, gray product formed. When the procedure was repeated at a temperature of 850° C., a black material with a green periphery was formed which exhibited a hardness characterized as very hard.

### EXAMPLE 3

An electrode active material having the formula Li₄VMn(PO₄)₃ is made as follows, using the reaction conditions of Example 1. The following starting materials are provided, and the reaction proceeds as follows.

3 (NH₄)₂HPO₄ + 2 Li₂CO₃ + MnO + 0.5 V₂O₅ + C →
Li₄VMn(PO₄)₃ + CO + 2 CO₂ + 4.5 H₂O + 6 NH₃

| | |
|---|---|
| 0.04 moles Li₂CO₃ (mol. wt. = 73.88 g/mol) | 2.96 g |
| 0.01 moles V₂O₅ (181.9 g/mol) | 1.82 g |
| 0.02 moles MnO (70.93 g/mol) | 1.42 g |
| 0.06 moles (NH₄)₂HPO₄ (132.06 g/mol) | 7.92 g |
| 0.02 moles elemental carbon (12 g/mol) | 0.24 g |

The above-noted mixture is then subjected to the reaction conditions specified in Example 1 to form the Li₄VMn(PO₄)₃ active material, except that the mixture is heated at a temperature of about 600° C. for 8 hours. An electrode active material synthesized by this method was light green in color.

### EXAMPLE 4

An electrode active material having the formula Li₄FeV(PO₄)₃ is made as follows using the reaction conditions of Example 1. The following starting materials are provided, and the reaction proceeds as follows.

0.5 Li₂CO₃ + Li₃PO₄ + FePO₄ + VPO₄ + 0.5 C →
Li₄FeV(PO₄)₃ + 0.5 CO + 0.5 CO₂

| | |
|---|---|
| 0.005 moles Li₂CO₃ (mol. wt. = 73.88 g/mol) | 0.37 g |
| 0.01 moles Li₃PO₄ (115.79 g/mol) | 1.16 g |
| 0.01 moles FePO₄ (150.82 g/mol) | 1.51 g |
| 0.01 moles VPO₄ (165.88 g/mol) | 1.66 g |
| 0.005 moles elemental carbon (12 g/mol) | 0.24 g |

The above-noted mixture is then subjected to the reaction conditions specified in Example 1 to form the Li₄FeV(PO₄)₃ active material, except that the mixture is heated at a temperature of about 750° C. for 8 hours in the presence of argon. An electrode active material synthesized by this method was black in color and soft.

### EXAMPLE 5

An electrode active material having the formula Li₄SnV(PO₄)₃ is made as follows, using the reaction conditions of Example 1. The following starting materials are provided, and the reaction proceeds as follows.

3 (NH₄)₂HPO₄ + 2 Li₂CO₃ + SnO + 0.5 V₂O₅ + C →
Li₄SnV(PO₄)₃ + CO + 2 CO₂ + 4.5 H₂O + 6 NH₃

| | |
|---|---|
| 0.02 moles Li₂CO₃ (mol. wt. = 73.88 g/mol) | 2.45 g |
| 0.005 mole V₂O₅ (181.9 g/mol) | 1.51 g |
| 0.01 mole SnO (134.7 g/mol) | 2.24 g |
| 0.03 moles (NH₄)₂HPO₄ (132.06 g/mol) | 6.56 g |
| 0.01 moles elemental carbon (12 g/mol) | 0.12 g |

The above-noted mixture is then subjected to the reaction conditions specified in Example 1 to form the Li₄SnV(PO₄)₃ active material, except that the mixture is heated at a temperature of about 850° C. for 8 hours in the presence of argon. An electrode active material synthesized by this method was brown/red in color.

### EXAMPLE 6

An electrode active material having the formula Li₅V₂(PO₄)₃ is made as follows, using the reaction conditions of Example 1. The following starting materials are provided, and the reaction proceeds as follows.

Li₃PO₄ + Li₂CO₃ + 2 VPO₄ + C → Li₅V₂(PO₄)₃ + CO + CO₂

| | |
|---|---|
| 0.01 moles Li₂CO₃ (mol. wt. = 73.88 g/mol) | 0.74 g |
| 0.01 moles Li₃PO₄ (115.79 g/mol) | 1.16 g |
| 0.02 moles VPO₄ (165.88 g/mol) | 3.32 g |
| 0.01 moles elemental carbon (12 g/mol) | 0.12 g |

The above-noted mixture is then subjected to the reaction conditions specified in Example 1 to form the Li₅V₂(PO₄)₃ active material, except that the mixture is heated at a temperature of about 900° C. for 8 hours in the presence of argon. An electrode active material synthesized by this method was black in color and soft.

### EXAMPLE 7

An electrode active material having the formula Li₄CoV(PO₄)₃ is made as follows, using the reaction conditions of Example 1. The following starting materials are provided, and the reaction proceeds as follows.

3 (NH₄)₂HPO₄ + 2 Li₂CO₃ + CoCO₃ + 0.5 V₂O₅ + C →
Li₄CoV(PO₄)₃ + CO + 3 CO₂ + 4.5 H₂O + 6 NH₃

| | |
|---|---|
| 0.04 moles Li₂CO₃ (mol. wt. = 73.88 g/mol) | 2.96 g |
| 0.01 mole V₂O₅ (181.9 g/mol) | 1.82 g |
| 0.02 mole CoO₃ (118.9 g/mol) | 2.38 g |
| 0.06 moles (NH₄)₂HPO₄ (132.06 g/mol) | 7.92 g |
| 0.02 moles elemental carbon (12 g/mol) | 0.24 g |

The above-noted mixture is then subjected to the reaction conditions specified in Example 1 to form the Li₄CoV(PO₄)₃ active material, except that the reactants were heated for 8 hours at 850° C. in the presence of argon. An electrode active material synthesized by this method was hard and black/purple in color.

### EXAMPLE 8

An electrode active material having the formula Li₄CuV(PO₄)₃ is made as follows, using the reaction conditions of Example 1. The following starting materials are provided, and the reaction proceeds as follows.

3 (NH₄)₂HPO₄ + 2 Li₂CO₃ + CuO + 0.5 V₂O₅ + C →
Li₄CuV(PO₄)₃ + CO + 2 CO₂ + 4.5 H₂O + 6 NH₃

| | |
|---|---|
| 0.04 moles Li₂CO₃ (mol. wt. = 73.88 g/mol) | 2.96 g |
| 0.01 mole V₂O₅ (181.9 g/mol) | 1.82 g |
| 0.02 mole CuO (79.55 g/mol) | 1.59 g |
| 0.06 moles (NH₄)₂HPO₄ (132.06 g/mol) | 7.92 g |
| 0.02 moles elemental carbon (12 g/mol) | 0.24 g |

The above-noted mixture is then subjected to the reaction conditions specified in Example 1 to form the Li₄CuV(PO₄)₃ active material. When the above-noted reactants were heated for 8 hours at 600° C., a red/gray product formed. When the procedure was repeated at a temperature of 850° C., a dark green product formed.

### EXAMPLE 9

An electrode active material having the formula Li₅Sn₂(PO₄)₃ is made as follows, using the reaction conditions of Example 1. The following starting materials are provided, and the reaction proceeds as follows.

3 (NH₄)₂HPO₄ + 2.5 Li₂CO₃ + 2 SnO →
Li₅Sn₂(PO₄)₃ + 2.5 CO₂ + 4.5 H₂O + 6 NH₃

| | |
|---|---|
| 0.025 moles Li₂CO₃ (mol. wt. = 73.88 g/mol) | 1.847 g |
| 0.02 moles SnO (134.7 g/mol) | 2.694 g |
| 0.03 moles (NH₄)₂HPO₄ (132.06 g/mol) | 3.962 g |

The above-noted mixture is then subjected to the reaction conditions specified in Example 1 to form the Li₅Sn₂(PO₄)₃ active material, except that the mixture is heated at a temperature of about 600° C. for 8 hours in the presence of argon. An electrode active material synthesized by this method was white in color.

### EXAMPLE 10

An electrode active material having the formula Li₅Ti₂(PO₄)₃ is made as follows, using the reaction conditions of Example 1. The following starting materials are provided, and the reaction proceeds as follows.

3 (NH₄)₂HPO₄ + 2.5 Li₂CO₃ + 2 TiO →
Li₅Ti₂(PO₄)₃ + 2.5 CO₂ + 4.5 H₂O + 6 NH₃

| | |
|---|---|
| 0.025 moles Li₂CO₃ (mol. wt. = 73.88 g/mol) | 1.847 g |
| 0.02 mole TiO (63.88 g/mol | 1.278 g |
| 0.03 moles (NH₄)₂HPO₄ (132.06 g/mol) | 3.962 g |

The above-noted mixture is then subjected to the reaction conditions specified in Example 1 to form the Li₅Ti₂(PO₄)₃ active material, except that the mixture is heated at a temperature of about 850° C. for 8 hours in the presence of argon. An electrode active material synthesized by this method was white in color and semi-hard.

### EXAMPLE 11

An electrode active material having the formula Li₄FeV(PO₄)₃ is made as follows using the reaction conditions of Example 1. The following starting materials are provided, and the reaction proceeds as follows.

2.333 (NH₄)₂HPO₄ + 2 Li₂CO₃ + 0.334 Fe₃(PO₄)₂ + 0.5 V₂O₃ →
Li₄FeV(PO₄)₃ + 2 CO₂ + 3.5 H₂O + 4.666 NH₃

| | |
|---|---|
| 0.02 moles Li₂CO₃ (mol. wt. = 73.88 g/mol) | 1.478 g |
| 0.005 mole V₂O₃ (149.9 g/mol) | 0.750 g |
| 0.00334 mole Fe₃(PO₄)₂ (293.5 g/mol) | 0.980 g |
| 0.0233 moles (NH₄)₂HPO₄ (132.06 g/mol) | 3.077 g |

The above-noted mixture is then subjected to the reaction conditions specified in Example 1 to form the Li₄FeV(PO₄)₃active material, except that the mixture is heated at a temperature of about 800° C. for 8 hours in the presence of argon. An electrode active material synthesized by this method was black in color and semi-hard.

### EXAMPLE 12

An electrode active material having the formula Li₄VMg(PO₄)₃ is made as follows using the reaction conditions of Example 1. The following starting materials are provided, and the reaction proceeds as follows.

3 (NH₄)₂HPO₄ + 2 Li₂CO₃ + Mg(OH)₂ + NH₄VO₃ + C →
Li₄VMg(PO₄)₃ + CO + 2 CO₂ + 6 H₂O + 7 NH₃

| | |
|---|---|
| 0.02 moles Li₂CO₃ (mol. wt. = 73.88 g/mol) | 1.48 g |
| 0.01 mole NH₄VO₃ (116.98 g/mol) | 0.91 g |
| 0.01 mole Mg(OH)₂ (58.33 g/mol) | 0.58 g |
| 0.03 moles (NH₄)₂HPO₄ (132.06 g/mol) | 3.96 g |
| 0.01 moles elemental carbon (12 g/mol) | 0.12 g |

The above-noted mixture is then subjected to the reaction conditions specified in Example 1 to form the Li₄VMg(PO₄)₃ active material, except that the mixture is heated at a temperature of about 850° C. for 8 hours in the presence of argon. An electrode active material synthesized by this method was black in color and hard.

Electrochemical Performance of Active Material:

For the active materials synthesized per Examples 1 through 6, electrochemical half-cells were prepared as follows. The cathode was prepared by solvent casting a slurry of the active material, conductive carbon, binder and solvent. The conductive carbon used was Super P (commercially available from MMM Carbon). Kynar Flex 2801 (commercially available from Elf Atochem Inc.) was used as the binder, and electronic grade acetone was used as the solvent. The slurry was cast onto glass and a free-standing electrode film was formed as the solvent evaporated. The electrode film contained the following components, expressed in percent by weight: 80% active material, 8% Super P carbon, and 12% Kynar 2801 binder. Lithium metal foil was employed as the anode. The electrolyte included ethylene carbonate (EC) and ethyl methyl carbonate (EMC) in a weight ratio of 2:1, and a 1 molar concentration of LiPF₆ salt. A glass fiber separator interpenetrated by the solvent and the salt was interposed between the cathode and the anode.

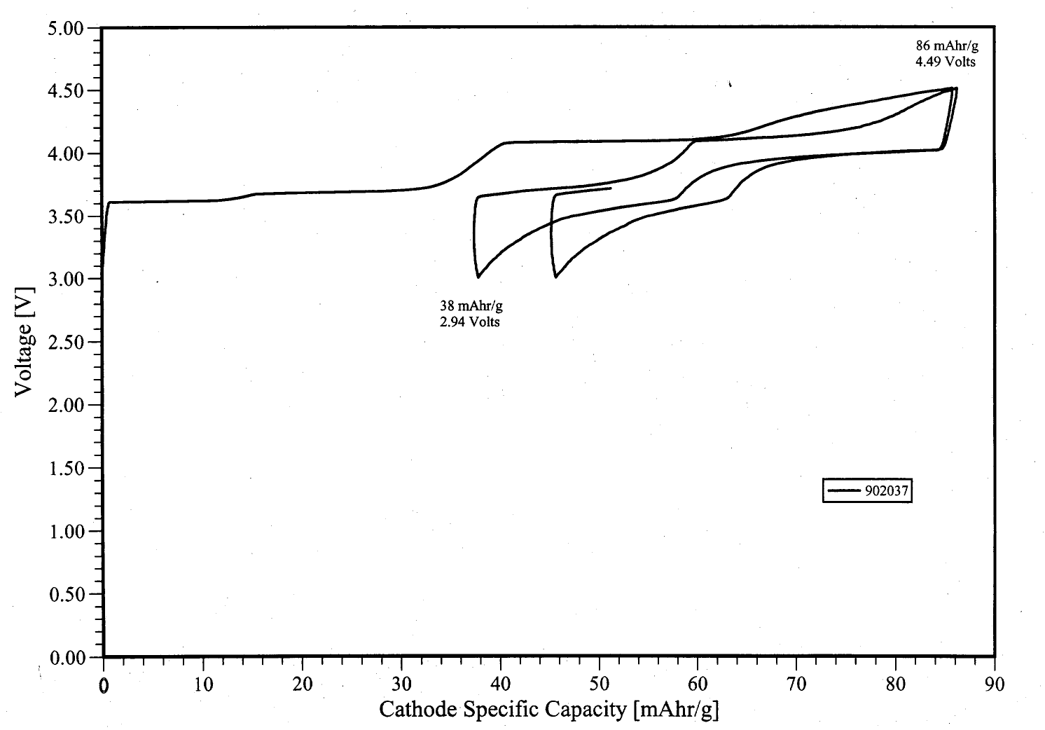

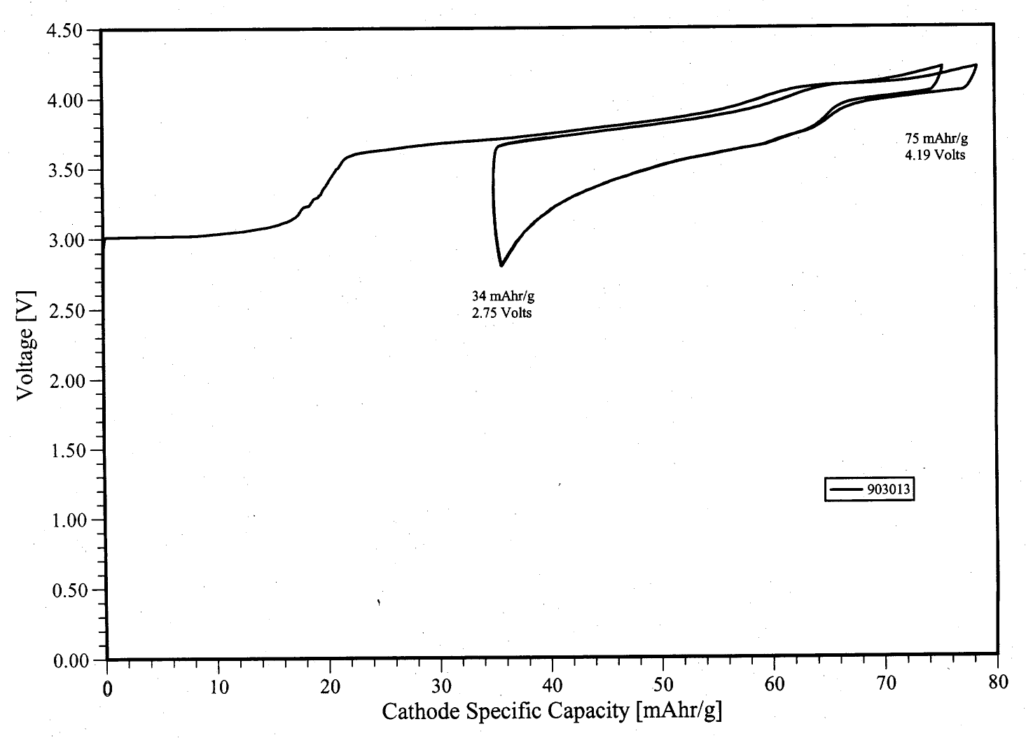

FIGS. 1 through 4 and 6 show active materials tested in electrochemical cells using the Electrochemical Voltage Spectroscopy (EVS) method. The EVS method is known in the art, and is described by J. Barker in The Journal of Power Sources, v. 52, pg. 185 (1994). In FIG. 5, the electrochemical cell was cycled using constant current cycling at ±0.2 milliamps per square centimeter (mA/cm²) in a range of about 3 V to about 4.5 V versus a lithium reference, at a temperature of about 23° C., at varying charge/discharge rates.

FIG. 1 is a plot of the cathode specific capacity as a function of voltage for an electrochemical cell constructed from the Li₄NiV(PO₄)₃ active material of Example 1. FIG. 1 shows the rechargeability of the Li₄NiV(PO₄)₃ cell, and also shows that the cell exhibited a charge specific capacity (corresponding to lithium extraction from the active material) of 86 mAhr/g at about 4.5 V, and a discharge specific capacity (corresponding to lithium insertion into the active material) of 48 mAhr/g at about 3 V.

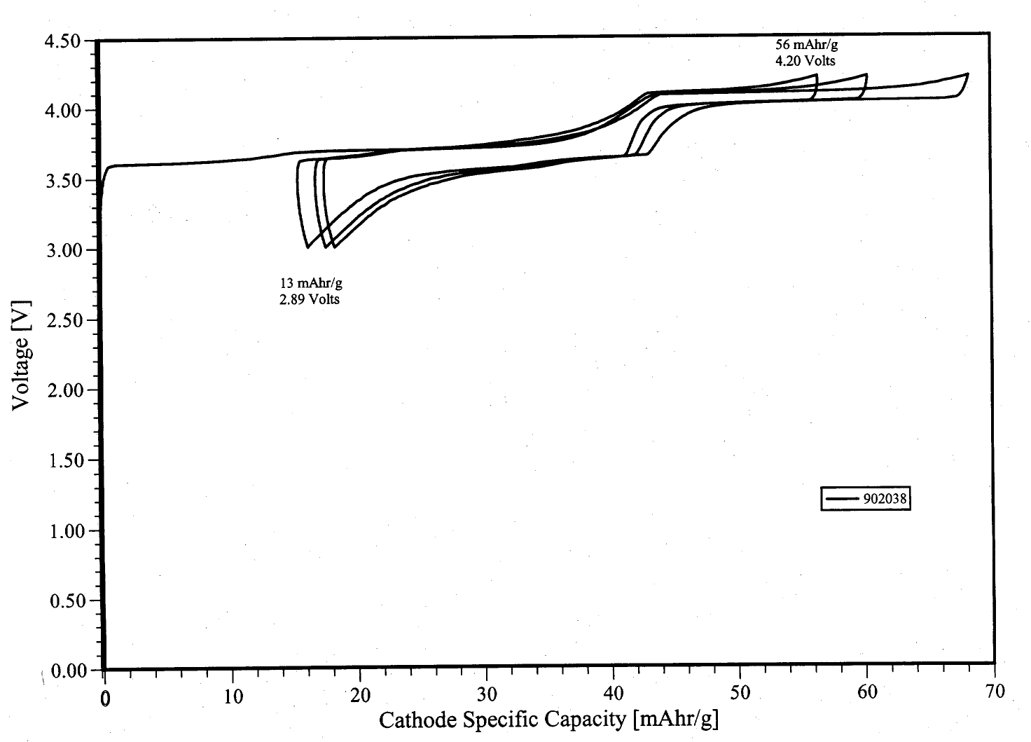

FIG. 2 is a plot of the cathode specific capacity as a function of voltage for an electrochemical cell constructed from the Li₄CoV(PO₄)₃ active material of Example 2. FIG. 2 shows the rechargeability of the Li₄CoV(PO₄)₃ cell, and also shows that the cell exhibited a charge specific capacity (corresponding to lithium extraction from the active material) of 56 mAhr/g at about 4.2 V, and a discharge specific capacity (corresponding to lithium insertion into the active material) of 43 mAhr/g at about 2.9 V.

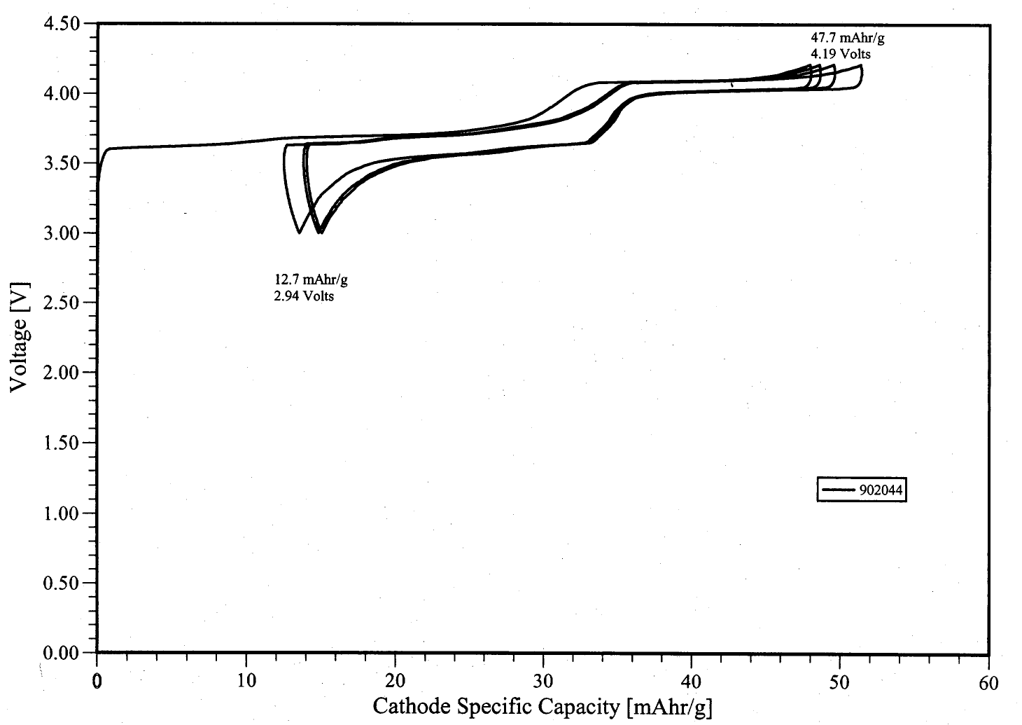

FIG. 3 is a plot of the cathode specific capacity as a function of voltage for an electrochemical cell constructed from the Li₄MnV(PO₄)₃ active material of Example 3. FIG. 3 shows the rechargeability of the Li₄MnV(PO₄)₃ cell, and also shows that the cell exhibited a charge specific capacity (corresponding to lithium extraction from the active material) of about 48 mAhr/g at about 4.2 V, and a discharge specific capacity (corresponding to lithium insertion into the active material) of about 35 mAhr/g at about 2.9 V.

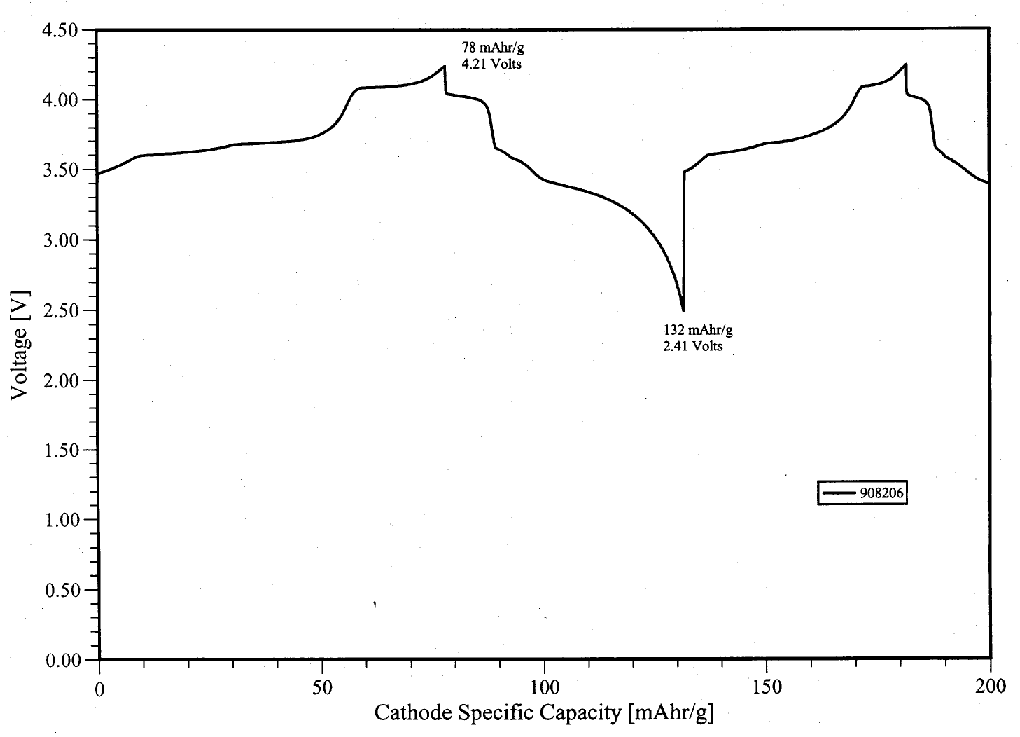

FIG. 4 is a plot of the cathode specific capacity as a function of voltage for an electrochemical cell constructed from the Li₄VFe(PO₄)₃ active material of Example 4. FIG. 4 shows the rechargeability of the Li₄VFe(PO₄)₃ cell, and also shows that the cell exhibited a charge specific capacity (corresponding to lithium extraction from the active material) of 78 mAhr/g at about 4.2 V, and a discharge specific capacity (corresponding to lithium insertion into the active material) of 132 mAhr/g at about 2.4 V.

FIG. 5 is a plot of the cathode specific capacity as a function of voltage for an electrochemical cell constructed from the Li₄SnV(PO₄)₃ active material of Example 5. FIG. 5 shows the rechargeability of the Li₄SnV(PO₄)₃ cell, and also shows that the cell exhibited a charge specific capacity (corresponding to lithium extraction from the active material) of 75 mAhr/g at about 4.2 V, and a discharge specific capacity (corresponding to lithium insertion into the active material) of 41 mAhr/g at about 2.75 V.

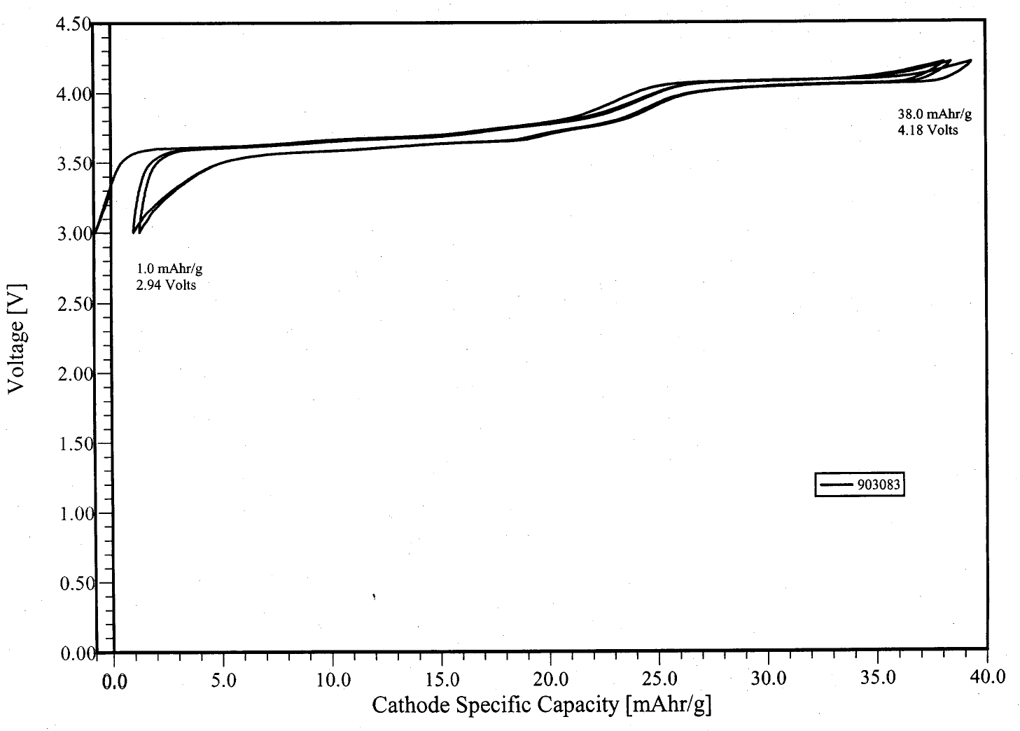

FIG. 6 is a plot of the cathode specific capacity as a function of voltage for an electrochemical cell constructed from the Li₅V₂(PO₄)₃ active material of Example 6. FIG. 6 shows the rechargeability of the Li₅V₂(PO₄)₃ cell, and also shows that the cell exhibited a charge specific capacity (corresponding to lithium extraction from the active material) of 38 mAhr/g at about 4.2 V, and a discharge specific capacity (corresponding to lithium insertion into the active material) of 37 mAhr/g at about 2.75 V.

It should be noted that each of the above-noted half-cells exhibited significantly lower charge and discharge specific capacities than expected (based on theoretical specific capacity considerations). While not wishing to be held to any one theory, the low capacities were likely attributable to insufficient mixing of the reactants. The electrochemical performance of these materials can be improved through optimization of the mixing of the reactants and/or by varying the reaction conditions that are taught herein.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A compound represented by the general formula AₐM₂₋ₘ^{I}Mₘ^{II}(XY₄)₃, wherein
(i) A is at least one alkali metal, wherein a=3+m and 3<a≦5;
(ii) M^{I} is selected from the group consisting of a redox active element with a 2+ oxidation state, a redox active element with a 3+ oxidation state, and mixtures thereof;
(iii) M^{II} is selected from the group consisting of a redox active element with a 2+ oxidation state, a redox active element with a 3+ oxidation state, a non-redox active element with a 2+ oxidation state, a non-redox active element with a 3+ oxidation state, and mixtures thereof;
(iv) XY₄ is selected from the group consisting of X′[O₄₋ₓ,Y′ₓ], X′[O_{4-y},Y′_{2y}], X″S₄, [X_{z}′″,X′_{1-z}]O₄, and mixtures thereof, wherein:
(a) X′ and X′″ are each independently selected from the group consisting of P, As, Sb, Si, Ge, V, S, and mixtures thereof;
(b) X″ is selected from the group consisting of P, As, Sb, Si, Ge, V, and mixtures thereof;
(c) Y′ is selected from the group consisting of a halogen, S, N, and mixtures thereof; and
(d) 0≦x≦3, 0≦y≦2, and 0≦z≦1; and
(v) 0<m<2;
wherein A, M^{I}, M^{II}, X, Y, a, m, x, y and z are selected so as to maintain electroneutrality of the compound.

2. The compound of claim 1, wherein A is selected from the group consisting of Li, K, Na, and mixtures thereof.

3. The compound of claim 1, wherein A is Li.

4. The compound of claim 1, wherein Ml is at least one redox active element with a 2+ oxidation state.

5. The compound of claim 4, wherein M^{I} is selected from the group consisting of Ti, V, Cr, Mn, Fe, Co, Ni, Cu, Mo, Si, Sn, Pb, and mixtures thereof.

6. The compound of claim 4, wherein M^{II} is at least one non-redox active element with a 2+ oxidation state.

7. The compound of claim 6, wherein M^{II} is selected from the group consisting of Be, Mg, Ca, Sr, Ba, Zn, Cd, C, Ge, and mixtures thereof.

8. The compound of claim 4, wherein M^{II} is at least one redox active element with a 2+ oxidation state.

9. The compound of claim 8, wherein M^{II} is selected from the group consisting of Ti, V, Cr, Mn, Fe, Co, Ni, Cu, Mo, Si, Sn, Pb, and mixtures thereof.

10. The compound of claim 4, wherein M^{II} is at least one non-redox active element with a 3+ oxidation state.

11. The compound of claim 10, wherein M^{II} is selected from the group consisting of Sc, Y, B, and mixtures thereof.

12. The compound of claim 4, wherein M^{II} is at least one redox active element with a 3+ oxidation state.

13. The compound of claim 12, wherein M^{II} is selected from the group consisting of Ti, V, Cr, Mn, Fe, Co, Ni, Mo, Nb, and mixtures thereof.

14. The compound of claim 1, wherein M^{I} is at least one redox active element with a 3+ oxidation state.

15. The compound of claim 14, wherein M^{II} is at least one non-redox active element with a 2+ oxidation state.

16. The compound of claim 15, wherein M^{II} is selected from the group consisting of Be, Mg, Ca, Sr, Ba, Zn, Cd, C, Ge, and mixtures thereof.

17. The compound of claim 14, wherein M^{II} is at least one redox active element with a 2+ oxidation state.

18. The compound of claim 17, wherein M^{II} is selected from the group consisting of Ti, V, Cr, Mn, Fe, Co, Ni, Cu, Mo, Si, Sn, Pb, and mixtures thereof.

19. The compound of claim 1, wherein XY₄ is selected from the group consisting of PO₄, AsO₄, SbO₄, SiO₄, GeO₄, VO₄, SO₄, and mixtures thereof.

20. The compound of claim 1, wherein XY₄ is PO₄.

21. A battery, comprising:
a first electrode comprising a compound represented by the general formula AₐM₂₋ₘ^{I}Mₘ^{II}(XY₄)₃, wherein
(i) A is at least one alkali metal, wherein a=3+m and 3≦a≦5;
(ii) M^{I} is selected from the group consisting of a redox active element with a 2+ oxidation state, a redox active element with a 3+ oxidation state, and mixtures thereof;
(iii) M^{II} is selected from the group consisting of a redox active element with a 2+ oxidation state, a redox active element with a 3+ oxidation state, a non-redox active element with a 2+ oxidation state, a non-redox active element with a 3+ oxidation state, and mixtures thereof;
(iv) XY₄ is selected from the group consisting of X′[O₄₋ₓ,Y′ₓ], X′[O_{4-y},Y′_{2y}], X″S₄, [X_{z}′″,X′_{1-z}]O₄, and mixtures thereof, wherein:
(a) X′ and X″ are each independently selected from the group consisting of P, As, Sb, Si, Ge, V, S, and mixtures thereof;
(b) X″ is selected from the group consisting of P, As, Sb, Si, Ge, V, and mixtures thereof;
(c) Y′ is selected from the group consisting of a halogen, S, N, and mixtures thereof; and
(d) 0≦x≦3, 0≦y≦2, and 0≦z≦1; and
(v) 0<m<2, wherein A, M^{I}, M^{II}, X, Y, a, m, x, y and z are selected so as to maintain electroneutrality of the compound;
a second counter electrode; and
an electrolyte in ion-transfer relationship with the first and second electrode.

22. The battery of claim 21, wherein A is selected from the group consisting of Li, K, Na, and mixtures thereof.

23. The battery of claim 21, wherein A is Li.

24. The battery of claim 21, wherein M^{I} is at least one redox active element with a 2+ oxidation state.

25. The battery of claim 24, wherein M^{I} is selected from the group consisting of Ti, V, Cr, Mn, Fe, Co, Ni, Cu, Mo, Si, Sn, Pb, and mixtures thereof.

26. The battery of claim 24, wherein M^{II} is at least one non-redox active element with a 2+ oxidation state.

27. The battery of claim 26, wherein M^{II} is selected from the group consisting of Be, Mg, Ca, Sr, Ba, Zn, Cd, C, Ge, and mixtures thereof.

28. The battery of claim 24, wherein M^{II} is at least one redox active element with a 2+ oxidation state.

29. The battery of claim 28, wherein M^{II} is selected from the group consisting of Ti, V, Cr, Mn, Fe, Co, Ni, Cu, Mo, Si, Sn, Pb, and mixtures thereof.

30. The battery of claim 24, wherein M^{II} is at least one non-redox active element with a 3+ oxidation state.

31. The battery of claim 30, wherein M^{II} is selected from the group consisting of Sc, Y, B, and mixtures thereof.

32. The battery of claim 24, wherein M^{II} is at least one redox active element with a 3+ oxidation state.

33. The battery of claim 32, wherein M^{II} is selected from the group consisting of Ti, V, Cr, Mn, Fe, Co, Ni, Mo, Nb, and mixtures thereof.

34. The battery of claim 21, wherein M^{I} is at least one redox active element with a 3+ oxidation state.

35. The battery of claim 34, wherein M^{II} is at least one non-redox active element with a 2+ oxidation state.

36. The battery of claim 35, wherein M^{II} is selected from the group consisting of Be, Mg, Ca, Sr, Ba, Zn, Cd, C, Ge, and mixtures thereof.

37. The battery of claim 34, wherein M^{II} is at least one redox active element with a 2+ oxidation state.

38. The battery of claim 37, wherein M^{II} is selected from the group consisting of Ti, V, Cr, Mn, Fe, Co, Ni, Cu, Mo, Si, Sn, Pb, and mixtures thereof.

39. The battery of claim 21, wherein XY₄ is selected from the group consisting of PO₄, AsO₄, SbO₄, SiO₄, GeO₄, VO₄, SO₄, and mixtures thereof.

40. The battery of claim 21, wherein XY₄ is PO₄.

41. A compound represented by the general formula AₐM₂₋ₘ^{I}Mₘ^{II}(PO₄)₃, wherein
(i) A is at least one alkali metal, wherein a=3+m and 3≦a≦5;
(ii) M^{I} is selected from the group consisting of a redox active element with a 2+ oxidation state, a redox active element with a 3+ oxidation state, and mixtures thereof;
(iii) M^{II} is selected from the group consisting of a redox active element with a 2+ oxidation state, a redox active element with a 3+ oxidation state, a non-redox active element with a 2+ oxidation state, a non-redox active element with a 3+ oxidation state, and mixtures thereof;
(v) 0<m<2;
wherein A, M^{I}, M^{II}, a and m are selected so as to maintain electroneutrality of the compound.

42. The compound of claim 41, wherein A is selected from the group consisting of Li, K, Na, and mixtures thereof.

43. The compound of claim 41, wherein A is Li.

44. The compound of claim 41, wherein M^{I} is at least one redox active element with a 2+ oxidation state.

45. The compound of claim 44, wherein M^{I} is selected from the group consisting of Ti, V, Cr, Mn, Fe, Co, Ni, Cu, Mo, Si, Sn, Pb, and mixtures thereof.

46. The compound of claim 44, wherein M^{II} is at least one non-redox active element with a 2+ oxidation state.

47. The compound of claim 46, wherein M^{II} is selected from the group consisting of Be, Mg, Ca, Sr, Ba, Zn, Cd, C, Ge, and mixtures thereof.

48. The compound of claim 44, wherein M^{II} is at least one redox active element with a 2+ oxidation state.

49. The compound of claim 48, wherein M^{II} is selected from the group consisting of Ti, V, Cr, Mn, Fe, Co, Ni, Cu, Mo, Si, Sn, Pb, and mixtures thereof.

50. The compound of claim 44, wherein M^{II} is at least one non-redox active element with a 3+ oxidation state.

51. The compound of claim 50, wherein M^{II} is selected from the group consisting of Sc, Y, B, and mixtures thereof.

52. The compound of claim 44, wherein M^{II} is at least one redox active element with a 3+ oxidation state.

53. The compound of claim 52, wherein M^{II} is selected from the group consisting of Ti, V, Cr, Mn, Fe, Co, Ni, Mo, Nb, and mixtures thereof.

54. The compound of claim 41, wherein M^{I} is at least one redox active element with a 3+ oxidation state.

55. The compound of claim 54, wherein M^{II} is at least one non-redox active element with a 2+ oxidation state.

56. The compound of claim 55, wherein M^{II} is selected from the group consisting of Be, Mg, Ca, Sr, Ba, Zn, Cd, C, Ge, and mixtures thereof.

57. The compound of claim 54, wherein M^{II} is at least one redox active element with a 2+ oxidation state.

58. The compound of claim 57, wherein M^{II} is selected from the group consisting of Ti, V, Cr, Mn, Fe, Co, Ni, Cu, Mo, Si, Sn, Pb, and mixtures thereof.
